(19) United States
(12) Patent Application Publication
(10) Pub. No.: US 2026/0298339 A1
(43) Pub. Date: Oct. 1, 2026

(54) SHIFT ACTUATOR

(71) Applicant: Shilla Industrial Co., Ltd., Gyeongsangbuk-do (KR)

(72) Inventor: Michael Z. CREECH, Ann Arbor, MI (US)

(21) Appl. No.: 19/483,295

(22) PCT Filed: May 9, 2024
(86) PCT No.: PCT/IB2024/000253

§ 371 Date: Nov. 11, 2025

Related U.S. Application Data
(60) Provisional application No. 63/502,696, filed on May 17, 2023.

(51) Int. Cl. F16H 63/30; F16H 63/32

(52) U.S. Cl. CPC F16H 63/304; F16H 63/32

(57) ABSTRACT

A shift actuator may have a housing having at least one curved slot, a sleeve located at least partially within the housing, a motor at least partially located in the sleeve, a gear reduction assembly located within the sleeve and rotationally connected to the motor and a rotary output member connected to the gear reduction assembly where the rotary output member extends at least partially into the slot.

### FIELD

A shift actuator, which may be adapted to move a drive device, is disclosed. The shift actuator may be used in a vehicle, such as in the transmission or drive train for the vehicle.

### BACKGROUND

Shift actuators are known devices that may be used to move a component of a transmission or in a drive train, such as in a vehicle. Current shift actuators suffer from several disadvantages. For example, current shift actuators have too many parts. The parts must be sourced from various suppliers, which may result in supply chain issues. Further, the numerous parts each provide as many failure modes for the actuator. In addition, current shift actuators, in part due to their many components, are inefficient and through the many connections between the parts, power is lost thus making them inefficient. Further yet, and this is also a result of the many parts, the current shift actuators are physically large making them heavy, awkward to handle during installation and shipping, in addition to taking up a large amount of space in an already crowded environment that could be used for other components.

In view of the disadvantages associated with the current shift actuators, it would be advantageous to have a shift actuator that minimized parts, that efficiently used power and that was compact and lightweight.

### BRIEF DESCRIPTION OF THE DRAWINGS

The above, as well as other advantages, will become readily apparent to those skilled in the art from the following detailed description when considered in the light of the accompanying drawings in which:

FIG. 1 is a schematic side view of one embodiment of a shift actuator;

FIG. 2 is a schematic cut away side view of the shift actuator;

FIG. 3 is a schematic side view of components of the shift actuator;

FIG. 4 is a schematic exploded side view of components of the shift actuator;

FIG. 5 is a schematic side view of the shift actuator in one embodiment of a transmission in a neutral condition and is associated with the position with the shift actuator shown in FIG. 1;

FIG. 6 is a schematic side view of the shift actuator in one embodiment of a transmission in a first engaged condition;

FIG. 7 is a schematic side view of one embodiment of the shift actuator in a position associated with the first engaged condition of the transmission of FIG. 6; and

FIG. 8 is a schematic side view of one embodiment of the shift actuator in a position associated with a second engaged condition of the transmission.

### DETAILED DESCRIPTION OF THE PREFERRED EMBODIMENTS

It is to be understood that the device may assume various alternative orientations and step sequences, except where expressly specified to the contrary. It is also to be understood that the specific devices and processes illustrated in the attached drawings, and described in the following specification are simply exemplary embodiments of the concepts herein. Hence, specific dimensions, directions or other physical characteristics relating to the embodiments disclosed are not to be considered as limiting, unless expressly stated otherwise.

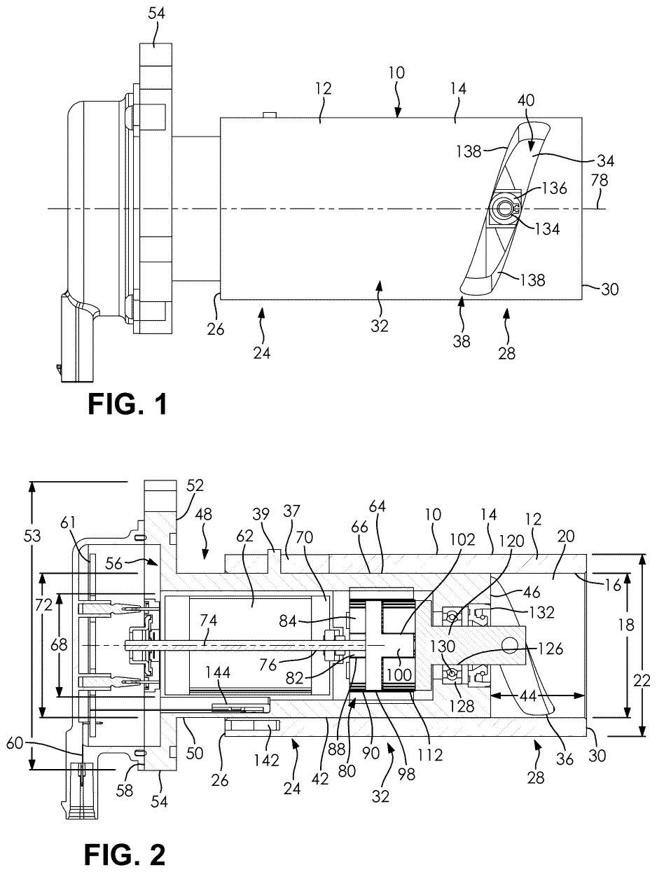

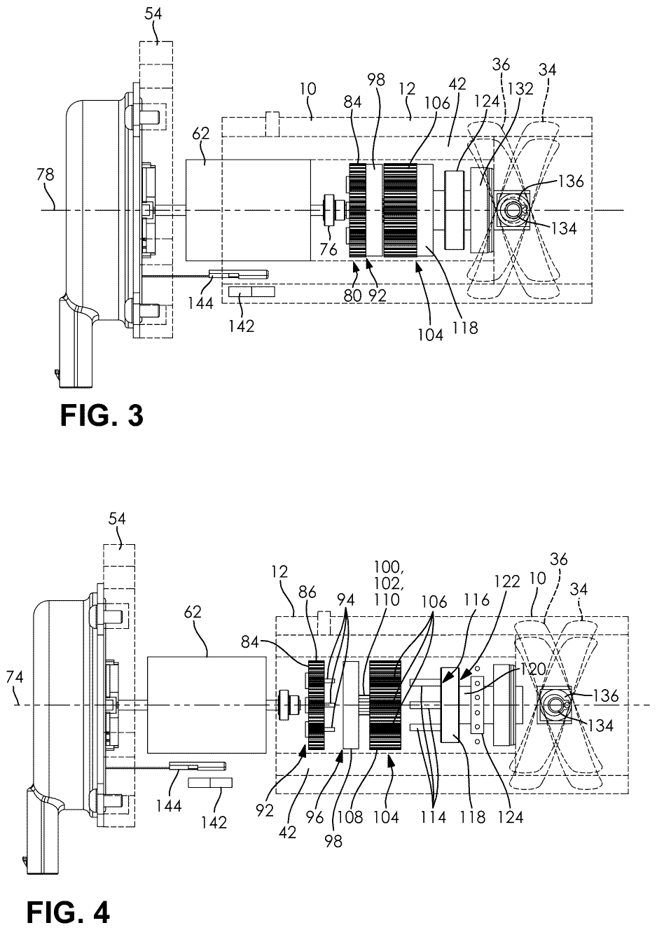

Turning now to FIGS. 1-4, one embodiment of a shift actuator 10 is schematically depicted. The shift actuator 10 may be comprised of a housing 12. The housing 12 may be a one piece, integrally formed and unitary housing 12, or the housing 12 may be constructed of one or more pieces or components.

In some embodiments, the housing 12 may have a circular or polygonal shaped cross-section. As shown in the figures, the housing 12 may be generally tubular having a curved outer surface 14 and a curved inner surface 16 with a complementary shape to the outer surface 14. The two surfaces 14, 16 may be separated from one another by a substantially constant thickness of the housing 12. The inner surface 16 may define an inner diameter 18, which may be substantially constant, and an interior void space 20. The outer surface 14 may define an outer diameter 22 that may be substantially constant.

The housing 12 may also have a first end portion 24, a first end 26, a second end portion 28 and a second end 30. A body portion 32 of the housing 12 may extend between the first and second ends 26, 30. With the housing 12 being tubular the first and second ends 26, 30 may be open.

The housing 12 may be substantially continuous except that at least one slot may be located in at least one of the end portions 24, 28. In one embodiment, the at least one slot may be generally located in the second end portion 28. It may be that there is a first slot 34 and a second slot 36 and the two slots are located in the second end portion 28. The slots 34, 36 may not be connected to one another, and it may be that the slots 34, 36 are located on oppose sides, or hemispheres, of the housing 12 from one another. The slots 34, 36 may be equally spaced from one another about the housing 12. Each slot 34, 36 may have a curved, such as at least partial helical, path extending along the housing 12 and entirely through the housing 12. In some cases, the path for each slot 34, 36 may be substantially the same and the slots 34, 36 may have the same pitch. In one case, the slot 34, 36 may extend along the housing 12 from a first longitudinal position 38, nearer the first end 26, to a second longitudinal position 40 nearer the second end 30. In other embodiments, more than two slots may be used.

The housing 12 may also have an opening 37 in the first end portion 24. The opening may receive a rotation lock device 39 from an inner sleeve (described below).

In some cases, an inner sleeve 42 may be located at least partially within the interior void space 20. The inner sleeve 42 may extend within the housing 12 along at least a portion of the length of the housing 12. As shown in the embodiment depicted in FIG. 2, the sleeve 42 may terminate before it reaches the second end 30 of the housing 12. This may leave a gap 44 between a second end 46 of the sleeve 42 and the second end 30 of the housing 12. A first end portion 48 of the sleeve 42 may extend out of the first end portion 24 of the housing 12. The first end portion 48 of the sleeve 42 may terminate in a first end 50.

The first end 50 may be connected to a second end 52 of a radially extending bolt flange 54. The bolt flange 54 may have a larger diameter 58 than the outer diameter 22 of the housing 12. The bolt flange 54 may be unitary, one-piece and integrally formed with the sleeve 42. The bolt flange 54 may have a hollow interior portion 56 extending from the second end 52 to a first end 58.

Electrical conductors 60 may be connected to the first end 58. The conductors 60 may be connected to a circuit board 61. The conductors 60 and/or board 61 may be connected to the motor 62 for control thereof.

The inner sleeve 42 may have a circular or polygonal shaped cross-section at least in part. As shown in the figures, the inner sleeve 42 may be at least partially tubular having a curved outer surface 64 and a curved inner surface 66 with a complementary shape to the outer surface 64. The two surfaces 64, 66 may be separated from one another by a substantially constant thickness of the inner sleeve 42 at least in part. The inner surface 66 may define an inner diameter 68 which may be substantially constant and an interior void space 70.

The outer surface 64 of the inner sleeve 42 may be a slightly smaller diameter 72 than the diameter 18 of the inner surface 16 of the housing 12 so that the sleeve 42 can be at least partially located within the interior void 20 of the housing 12.

In one embodiment, the motor 62 may be located in the first end portion 48 of the inner sleeve 42 in the interior void 70 of the sleeve 42. The motor 62 may be fixed against rotation and axial movement with respect to the sleeve 42. The motor 62 may be such as an electric motor connected to the circuit board 61 and a source of electric power (not shown). The motor 62 may be located within the inner sleeve 42 so than a longitudinal axis 74 of the motor 62, including an output shaft 76 of the motor 62, are colinear or coaxial with a longitudinal axis 78 of the shift actuator 10. The output shaft 76 may be adapted for rotation in a clockwise and counterclockwise direction.

The output shaft 76 of the motor 62 may be connected to a gear set 80 or a gearbox (which may contain the gear set), which may also be located within the inner sleeve 42.

In one embodiment, the motor output shaft 76 may be connected to a sun gear 82 of the gear set 80. By way of one example, the sun gear 82 may be mounted on the output shaft 76, such as in a concentric fashion.

The gear set 80 may be such as a reduction gear set. The gear set 80 may also comprise a plurality of planetary gears 84 having outer diameter teeth 86 in meshed engagement with outer diameter teeth 88 of the sun gear 82. The outer diameter teeth 86 of the planetary gears 84 may also be in meshed engagement with a first ring gear 90. The planetary gears 84 and the sun gear 82 may comprise a first planetary gear set 92. The planetary gears 84 may be mounted on axles 94 longitudinally extending from a carrier 98.

The carrier 98 may have a stub-shaft 100 extending along the longitudinal axis 78 where the stub-shaft 100 has teeth for a second sun gear 102 of a second planetary gear set 104. The second planetary gear set 104 may also comprise a plurality of planetary gears 106 having outer diameter teeth 108 in meshed engagement with outer diameter teeth 110 on the sun gear 102. The outer diameter teeth 108 of the planetary gears may also be in meshed engagement with a second ring gear 112. The planetary gears 106 may be mounted on axles 114 longitudinally extending from a first side 116 of second carrier 118.

The carrier 118 may have a longitudinally extending stub-shaft 120. The stub-shaft 120 may longitudinally extend from a second side 122 of the carrier 118. The stub-shaft 120 may be mounted for rotation within at least the sleeve 42 and may extend longitudinally into at least a portion of the housing 12. The stub-shaft 120 may be supported within the sleeve 42 by at least one bearing 124, comprising as an inner race 126, an outer race 128 and a plurality of ball bearings 130 between the races 126, 128. A seal 132 may be located longitudinally adjacent the bearing 124 to keep lubricant from leaking out of the hollow interior 70 of the sleeve 42 and to keep contaminants from infiltrating into the hollow interior 70 of sleeve 42.

The reduction gear set 80 may be designed to reduce the motor output shaft 76 revolutions to a predetermined number of revolutions. The predetermined number of revolutions may be less than the revolutions of the motor output shaft 70. In one case, the reduction ratio between the motor output shaft 76 and the gear set 80 may be such as 40:1.

The stub-shaft 120 may have at least one rotary output member 134 laterally extending therefrom. The member 134 may be rod-shaped and have a circular cross-section, but other geometries may be used for the member 134. In one embodiment, member 134 may be two pins extending from the stub-shaft 120. The pins 134 may extend generally perpendicular to the longitudinal axis 78 and they may extend generally opposite one another, such as approximately 180 degrees from one another off of the stub-shaft 120. In another embodiment, the rotary output member 134 may be such as a single pin or rod. In such a case, the rotary output member 134 may be such as one piece, integrally formed and unitary.

The pins 134 may extend into the slots 34, 36 of the housing 12. In some cases, friction reduction devices 136, such as rollers or low friction bushings, may be located on the pins 134 where they extend into the slots 34, 36. The devices 136 may contact the side walls 138 that define the openings of the slots 34, 36 and facilitate movement between the devices 136 and the slots 34, 36.

In some cases, a drive device 140 may be connected to the outer surface 14 of the housing 12. The drive device 140 may be such as a shift fork or a shift collar. The drive device 140 may extend generally transverse the outer surface 14 and it may be fixedly connected to the housing 12 so that it moves with the housing 12.

In one embodiment of the operation of the actuator 10, electric power is provided to the motor 62 and it provides rotational energy to the first sun gear 82 of the first set of planetary gears 84. The sun gear 82 rotates the planetary gears 84 against the stationary first ring gear 90. The carrier 98 to which the planets 84 are attached rotates as a result. The second sun gear 102, being attached to the carrier 98, rotates with the carrier 98 and provides rotational input to the second planetary gear set 104.

Rotation of the second sun gear 102 rotates the second set of planetary gears 104 within the second stationary ring gear 112. The second set of planetary gears 104, being mounted on the second carrier 118, rotates the carrier 118 and its stub-shaft 120.

The stub-shaft 120 rotates the member 134. While one member 134 may be used, multiple members 134 provides for evenly shared forces, so multiple members 134 may be preferred. As noted above, the members 134 may be designed to slide in the angular (or at least partially helical) slots 34, 36 in the housing 12. As the members 134 slide in the helical slots 34, 36 axial force is created and causes the housing 12 to rotate to translate in the along the longitudinal axis 78. The slots 34, 36 having the same general size, shape and pitch impart the same longitudinal translation to the housing 12 for a given rotation of the rotary output member 134 It can be readily appreciated that a structure attached to the housing 12 will be imparted with a longitudinal movement as well.

The circuit board 61 may be adapted to monitor a sensor target 142. When the board 61 notes the sensor target 142 has reached a desired location the board 61 will stop the rotation of the motor 62. While a board 61 is mentioned, it may be possible to eliminate the board 61 and use other control devices.

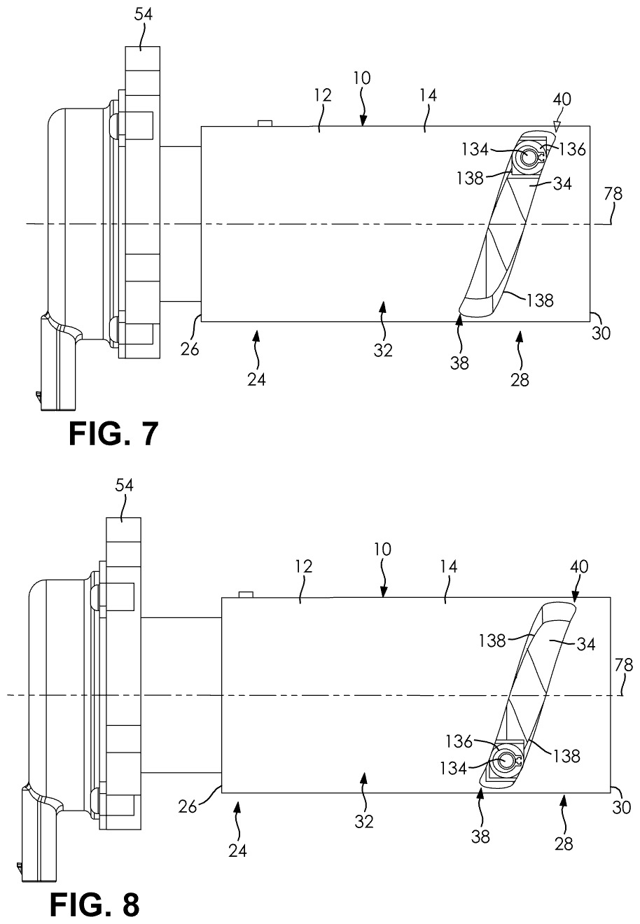

It may be appreciated that rotation of the motor 62 in a first direction causes the drive device 140 to move in a first direction along the longitudinal axis 78 while rotation in a second direction, opposite the first direction, moves the drive device 140 in a second direction along the longitudinal axis 78. For example, FIG. 7 schematically depicts the housing having shifted in the first direction. And, FIG. 8 schematically depicts the housing having shifted in the second direction. It can be readily appreciated in both figures that the drive device, being attached to the housing, respectively moves.

In some cases, a sensor 144 may be located on or in the inner sleeve 42 or the motor 62. The sensor 144 may be adapted to detect the sensor target 142. The target 142 may be a magnet or related device that can be detected by the sensor 144. The target may located on the drive device 140 or the housing 12, for example. This permits for a highly accurate reading of the drive device position. In other cases, no sensor is required.

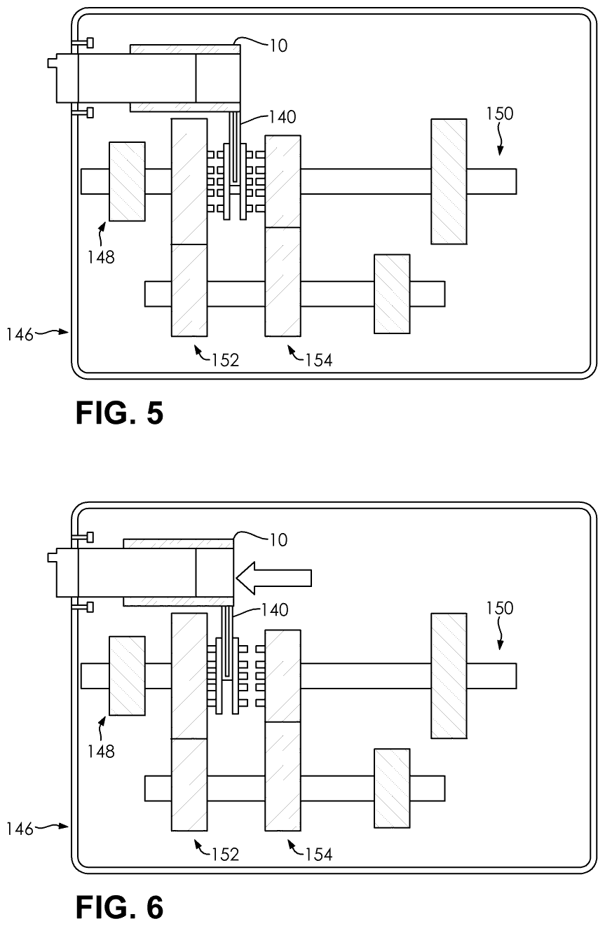

Turning now to FIGS. 5 and 6, one embodiment of the shift actuator 10 located in a transmission 146 is schematically depicted. From the figures, it can be seen that the shift actuator 10 may move a drive device 140 among at least three positions: neutral, a first shift position and a second shift position. In the neutral position, the transmission 146 does not have power flowing from an input side 148 to an output side 150 of the transmission 146. The actuator 10 may be such as in the condition shown in FIG. 1 to achieve this affect in the transmission.

When the drive device 140 is moved by the actuator 10, a first gear set 152 at the first shift position is engaged, causing power to flow from the input side 148 to the output side 150 of the transmission, as shown in FIG. 6. The actuator 10 may be such as in the condition shown in FIG. 7 to achieve this affect in the transmission.

The actuator 10 may be such as in the condition shown in FIG. 8 to connect rotational power from the input side 148 through a second gear set 154.

Thus, from the above, it can be appreciated that shift actuator 10 can also move the drive device 140 from neutral drive to the second shift position, or from the first to the second shift position, and vice versa.

The shift actuator 10 may be provided with a signal to affect a shift through a communication system, which may be wired and/or wireless. The signal may be provided to the circuit board 61 and/or the motor 62. The board 61 may monitor the position of the drive device 140 and through the sensor 144 and sensor target 142, the board 61 may know, for example, that the drive device 140 is in a neutral position, a pre-engagement position or an engaged in a first or second shift position. The board 61 turns on a transistor or multiple transistors (which may be part of an H-bridge design) and allows the current to flow into the motor 62 in the direction that initiates the desired movement.

From the foregoing, it can be appreciated that by locating at least the motor 62 and the gear set 80 in a single, compact housing 12, a significant space saving is achieved as well as part reduction compared to the prior art. The other noted disadvantages of the art are also overcome.

In accordance with the provisions of the patent statutes, the device has been described in what is considered to represent its preferred embodiments. However, it should be noted that the device can be practiced otherwise than as specifically illustrated and described without departing from its spirit or scope.

What is claimed is:

1. A shift actuator, comprising:
a longitudinally translatable housing having at least one curved slot in an outer surface;
a non-rotatable sleeve located at least partially within the housing;
a motor at least partially located in the sleeve, the motor having a rotatable output shaft longitudinally aligned with an actuator axis;
a gear reduction assembly located within the sleeve and rotationally connected to the output shaft; and
a rotary output member connected to the gear reduction assembly where the rotary output member extends at least partially into the slot.

2. The shift actuator of claim 1, wherein the housing is tubular having a first end, a first end portion, a second end and a second end portion and a body portion located between the ends, wherein the slot is located in the second end portion, wherein a sensor and sensor target are located adjacent the first end portion.

3. The shift actuator of claim 1, wherein the outer surface of the housing is curved and the slot extends through the housing from a first longitudinal position to a second longitudinal position along the outer surface of the housing.

4. The shift actuator of claim 2, wherein a first end portion of the sleeve extends longitudinally out of the first end of the housing and a second end portion of the sleeve is radially covered by the second end portion of the housing and the sleeve longitudinally terminates before reaching the slot in the housing.

5. The shift actuator of claim 1, wherein the gear reduction assembly comprises a first gear reduction assembly longitudinally connected to a second gear reduction assembly.

6. The shift actuator of claim 5, wherein the first gear reduction assembly comprises a first sun gear on the motor output shaft and a plurality of planetary gears meshed with the first sun gear and a ring gear in the sleeve, wherein the planetary gears are located on a first side of a first carrier.

7. The shift actuator of claim 6, wherein the carrier has stub-shaft extending from a second side, wherein the stub-shaft has a second sun gear of the second gear reduction assembly connected thereto.

8. The shift actuator of claim 7, wherein the second gear reduction assembly has a plurality of planetary gears meshed with the second sun gear and a second ring gear, the plurality of planetary gears being carried on a first side of a second carrier.

9. The shift actuator of claim 8, wherein the second carrier has a stub shaft extending from a second side, wherein the rotary output member is connected to the stub shaft for rotation therewith.

10. The shift actuator of claim 9, wherein the rotary output member is a radially extending rod that extends into the at least one slot.

11. The shift actuator of claim 1, wherein a shift fork or shift collar are fixedly connected to an outside surface of the housing.

12. The shift actuator of claim 1, wherein the housing has an inner surface with a complementary shape to the outer surface, wherein the inner surface has a first radius and the outer surface has a second radius larger than the first radius, wherein the radii define a substantially constant thickness between them and the slot extends entirely through the thickness.

13. The shift actuator of claim 1, wherein the at least one curved slot is a first slot and a second slot of substantially equal length to the first slot is located in the rotatable housing opposite the first slot.

14. The shift actuator of claim 1, wherein the rotatable housing is substantially cylindrical and located at least partially in a concentric position with respect to the non-rotatable sleeve which is also substantially cylindrical and wherein the motor is located at least partially in a concentric relationship with the non-rotatable sleeve.

15. The shift actuator of claim 10, wherein a low friction structure extends about an end portion of the radially extending rod, the low friction structure at least partially engaged with a wall of at least one of the slots.
